(19) United States
(12) Patent Application Publication
(10) Pub. No.: US 2004/0110566 A1
(43) Pub. Date: Jun. 10, 2004

(54) VIDEO GAME JUKEBOX

(76) Inventor: Steven H. Schneider, Wayland, MA (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/604,397

(22) Filed: Jul. 17, 2003

Related U.S. Application Data
(60) Provisional application No. 60/396,872, filed on Jul. 18, 2002.

(51) Int. Cl. G06F 19/00; G06F 17/00

(52) U.S. Cl. 463/43

(57) ABSTRACT

A video game player, a disk storage device, a videodisk transfer device, a title display, a user operable videodisk selector and a control. The video game player includes a videodisk player. The videodisk player having a disk interface for reading game data on a videodisk and the videodisk player receiving user input from one or more game controller(s) and displays game play with a video display. The disk storage device is for storing multiple videodisks. The title display is for displaying to users the images of videodisk titles that are in the disk storage device. The control responds to a selection made with the videodisk selector and controls the videodisk transfer device to retrieve a selected videodisk from the disk storage device and transfer the retrieved videodisk to the video game player.

### CROSS REFERENCE TO RELATED APPLICATIONS

This application claims priority from U.S. provisional patent application Serial No. 60/396,872, filed on Jul. 18, 2002, the disclosure of which is hereby incorporated herein by reference in its entirety.

### BACKGROUND OF INVENTION

The present invention relates to a video game apparatus and, in particular, to a video game apparatus that may be used in the marketing, selling and/or merchandising of video games and in the playing of video games at video arcades and other venues accessible to the public. Other applications may be found, such as a home used device, and the like.

The present technique for demonstrating video games is done by encasing a video game player in a plastic housing, preloading a video game in the game player and presenting the apparatus for the consuming public to demonstrate. More than one such apparatus may be provided to allow more than one game to be demonstrated at a time and each of the several manufacturers of video games may have such an apparatus featuring its video game player apparatus and video games. The difficulties with such techniques are numerous. Only a few video game titles can be demonstrated. If more than one user wishes to demonstrate a particular video game title, a queue will form behind the user presently demonstrating the game. Moreover, only a few titles from the vast libraries of each manufacturer can be demonstrated. Most are inaccessible to the potential purchasers.

Present video arcade games are stand-alone units that are loaded with a single game or family of games. Because video arcade games become obsolete, it is necessary to occasionally change out the entire stand-alone unit and replace it with a new stand-alone unit or retrofit the existing cabinet and unit for a new one. The number of video arcade game titles that can be accommodated is limited by the floor space that is available to video arcade games.

### SUMMARY OF INVENTION

A video game apparatus and method according to the invention includes providing a video game player, a disk storage device, a videodisk transfer device, a title display, a user operable videodisk selector and a control. The video game player includes a videodisk player. The videodisk player having a disk interface for reading game data on a videodisk and the videodisk player receiving user input from one or more game controller(s) and displays game play with a video display. The disk storage device is for storing multiple videodisks. The title display is for displaying to users the images of videodisk titles that are in the disk storage device. The control responds to a selection made with the videodisk selector and controls the videodisk transfer device to retrieve a selected videodisk from the disk storage device and transfer the retrieved videodisk to the video game player.

These and other objects, advantages and features of this invention will become apparent upon review of the following specification in conjunction with the drawings.

### BRIEF DESCRIPTION OF DRAWINGS

FIG. 1 is a block diagram of a video game apparatus according to the invention;

FIG. 2 is the same view as FIG. 1 of an alternative embodiment;

FIG. 3 is the same view as FIG. 1 of another alternative embodiment;

FIG. 4 is a perspective view of a videodisk storage device and transfer device; and

FIG. 5 is an electronic schematic diagram of a video game apparatus.

### DESCRIPTION OF THE PREFERRED EMBODIMENT

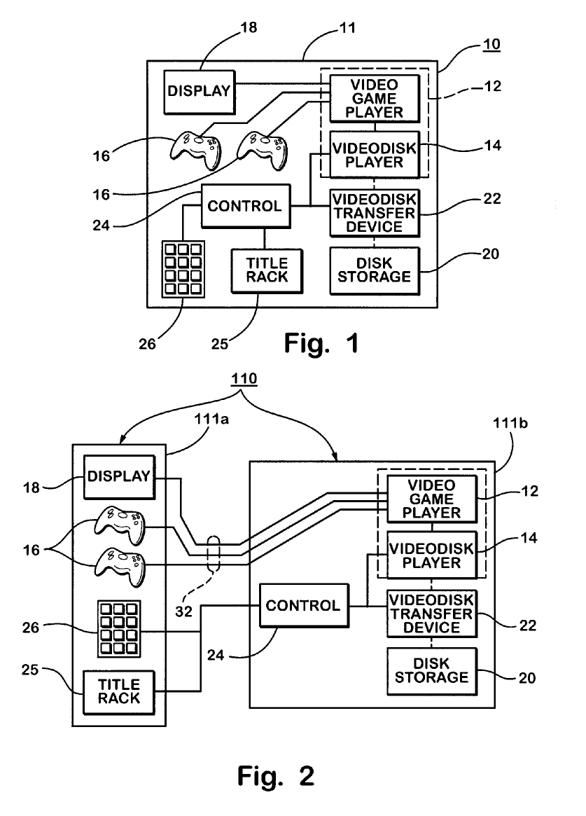

Referring now to the drawings and the illustrative embodiments depicted therein, a video game apparatus 10 includes a video game player 12, a disk storage device 20 for storing multiple videodisks, a videodisk transfer device 22, a user operable videodisk selector 26 and a control 24 (FIGS. 1-3). Video game apparatus further includes a title display 25 for displaying to users images of videodisk titles that are in disk storage device 20. Video game player 12 includes a videodisk player 14, one or more game controllers 16 and a video display 18. The videodisk player has a disk interface for reading game data on a videodisk. The videodisk player receives user input from the game controller(s) and displays game images with the video display. Video game player 12 is a commercially available system that plays video games stored on a videodisk, such as a digital videodisk (DVD). Video game players are presently marketed by Sony Corporation under the Playstation II brand, the Nintendo Corporation under the GameCube brand and Microsoft Corporation under the X-Box brand. However, other video game players may be developed and newer versions of existing players may come to market. The invention is intended to encompass all such video game players.

Video game apparatus 10 may be housed in a housing, such as a kiosk housing 11, which is intended to be commercially pleasing in appearance and durable in structure. Video storage device 20 is capable of being loaded with a large number, such as dozens or even hundreds, of videodisks of the type that are useable with videodisk player 14. Thus, if the videodisk player is a Nintendo GameCube®, video storage device 20 is configured to store multiple GameCube video game disks. Videodisk transfer device 22 is capable of selectively choosing one of the multiple video game disks stored in disk storage device 20, removing that disk from storage device 20 and placing the selected disk in operative association with videodisk player 14. Videodisk transfer device 22 is also capable of retrieving a disk from videodisk player 14 and placing that disk back in disk storage device 20. Videodisk transfer device 22 and disk storage device 20 may of the type used in commercially available audio jukeboxes, such as disclosed in FIG. 4 in which disk storage device 20 is moveable to bring the selected disk into juxtaposition with disk transfer device 22, the details of which are further disclosed in commonly assigned U.S. Pat. No. 5,050,148 the disclosure of which is hereby incorporated herein by reference. In other examples, such as disclosed in commonly assigned U.S. Pat. No. 6,373,796, the disclosure of which is hereby incorporated herein by reference, the disk storage device is stationary and the disk transfer device moves to the location of the selected disk. Game controllers 16 are of the type included with videodisk player 14 and typically number between one and four controllers.

Control 24 may be a dedicated controller or a microcomputer-based controller or a combination of both. Control 24 is programmed with software that is capable of receiving user input selections made with disk selector 26. Disk selector 26 could be a stand-alone hardware selector, such as a keypad, or it could be a touch pad system incorporated in video display 18 and under the control of control 24. Disk selector 26 could also be a separate video display and touch pad combination dedicated to this function. In the later embodiment, video display would be provided with touch pads useable to select the video game title by touching a location on video display 18 associated with the desired title. Title display 25 may be a titled rack for holding images printed on game jackets that come with each video game title. Examples of such title racks are disclosed in commonly assigned U.S. Pat. Nos. 5,704,146 and 5,031,346, the disclosures of which are hereby incorporated herein by reference. Title display 25 may alternatively comprise control 24 causing display of video game titles available for selection on video display 18. Such embodiment is most adaptable for use with a touch screen display for selecting disks. The control may display the titles in a layered tree format, such as by category of games, common game characters, or the like. Once a user selects a particular game title to be played, disk changer 22 removes and replaces any disk that may be presently loaded on videodisk player 14, locates the selected disk in disk storage device 20 and moves the selected disk to videodisk player 14.

In the embodiment illustrated in FIG. 1, substantially all of the described components are located on or in or at kiosk housing 11. In an alternative embodiment illustrated in FIG. 2, a housing 111a is provided at a location where it can be accessed by potential customers of video games. At least video display 18, game controller(s) 16 title display 25 and disk selector 26 are located in housing 111a, such as in a retail store shopping space or at a video arcade, or the like. A housing 111b can be located remotely from housing 111a, such as in a back room, behind a counter or a partition, or the like. Control 24, disk storage device 20 and videodisk player 14 may be located in housing 111b. A cable 32 may be used to interconnect control 24 and/or disk reader 14 with title display 25, disk selector 26, game controller(s) 16 and video display 18. Alternatively, the structure and functions of control 24 may be divided between housings 111a and 111b with the control sections interconnected, such as with a serial connection, a multiplexed connection, or the like.

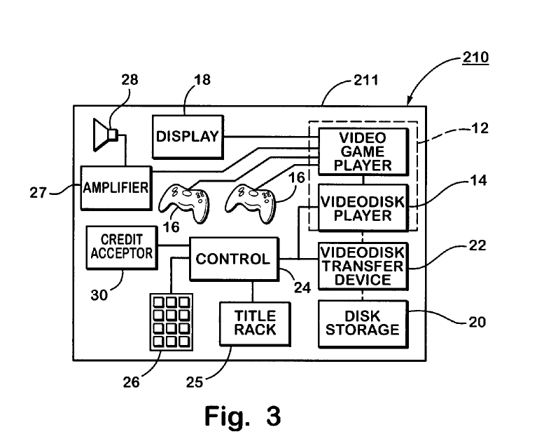

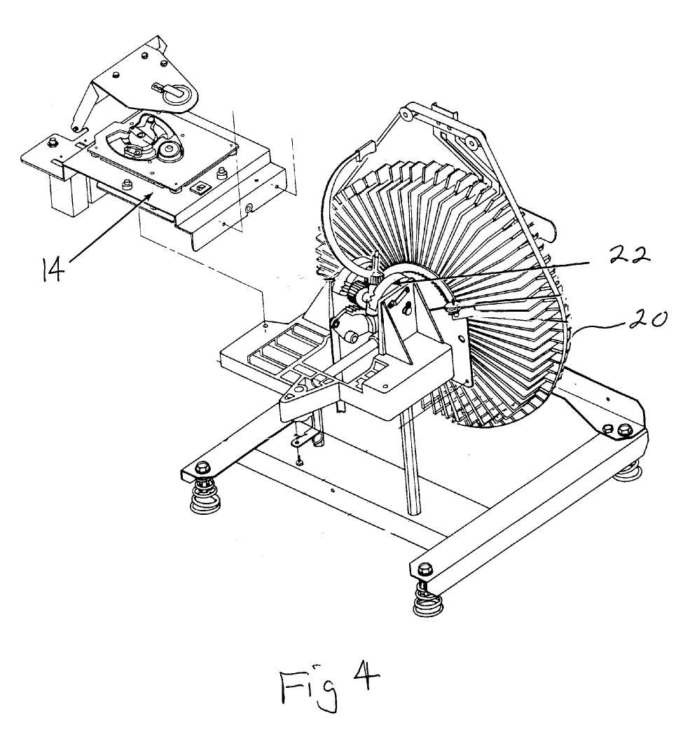

In an embodiment illustrated in FIG. 3 a video game apparatus 210 includes a credit acceptor 30. This allows video game apparatus 10 to be used for commercial play of games, such as at a video arcade. Credit acceptor 30 may be a credit/debit card reader, a smart card reader, a bill acceptor, a coin acceptor, or some combination of such devices. The video game apparatus includes a housing 211 that may include one or more amplifiers 27 and speaker 28. Amplifier 27 and speaker 28 are for the purpose of providing a high quality experience to the user by outputting sounds produced by the game being played.

Video game apparatus 10, 110, 210 may have an attract mode, or default mode. In particular, recently released games or games associated with a particular movie, or other criteria may be played on videodisk player 14 as a default in order to promote sale or use of a particular game. Alternatively, control 24 could include video code intended to display images of a particular game, such as when apparatus 10, 110, 210 is not being used, in order to promote that game.

Although the best mode of the invention is illustrated for commercial settings, it should be understood that it is not limited to such settings. For example, the invention may find use as a consumer appliance that can be used in a user's residence or other such non-commercial setting.

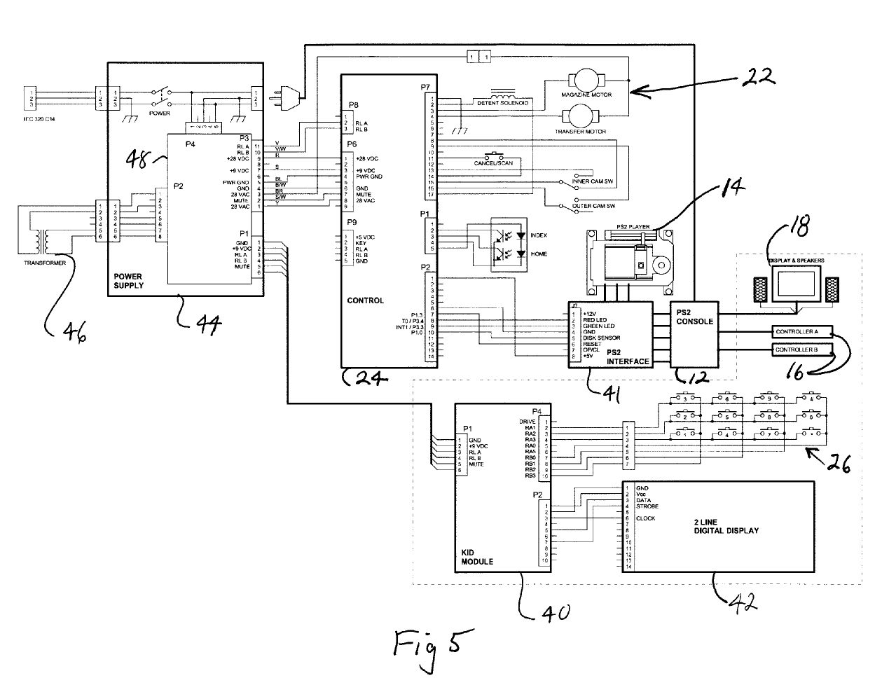

Referring now to FIG. 5 in a preferred embodiment, CD storage and transfer mechanism 20 includes a magazine motor, transfer motor, detent solenoid, cancel/scan switch, inner cam switch, outer cam switch, and home/index optical switch. The videodisk player 14, which is illustrated as a PS2 Player, is located in a position to receive the game disk from the CD storage and transfer mechanism 22. A PS2 interface board 41 is connected between the PS2 Player and PS2 Console and connected to the control so that the control can send and monitor signals to and from the PS2 Console to control the operation of the PS2 Console. The monitor and speakers 18 and the game controllers 16 are connected to the PS2 Console.

A Keyboard/Display Module (KID Module) 40 is connected to control 24 by a 6-wire cable routed through a power supply 44. Serial control signals are sent to the KID Module from control 24 to display messages on a 2-Line Digital Display 42. Control 24 receives user input by keypad signals from the 12-key Keypad 26.

Power supply 44 includes a transformer 46 and power supply circuit board 48 to generate the low voltages the components need to operate.

Changes and modifications in the specifically described embodiments can be carried out without departing from the principles of the invention, which is intended to be limited only by the scope of the appended claims, as interpreted according to the principles of patent law including the Doctrine of Equivalents.

1. A video game apparatus for use with at least one game controller and a video display, said apparatus comprising:
a video game player having a videodisk player, and electrical connections for connecting a video controller and a video display, said videodisk player having a disk interface for reading game data on a videodisk, said videodisk player receiving user input from at least one game controller and generating video output for displaying game play with a video display;
a disk storage device for storing multiple videodisks;
a title display for displaying to users images of videodisk titles that are in said disk storage device;
a videodisk transfer device;
a user operable videodisk selector; and
a control which responds to a selection made with said videodisk selector and controls said videodisk transfer device to retrieve a selected videodisk from said storage device and transfers the selected videodisk to said video game player.

2. The video game apparatus in claim 1 wherein said videodisk selector is located remote from said videodisk player, said storage device and said videodisk transfer device.

3. The video game apparatus in claim 2 including a kiosk housing, wherein said videodisk selector is housed in said kiosk housing with a video display and at least one game controller.

4. The video game apparatus in claim 1 including a kiosk housing for said video game player, said disk storage device, said disk changer, said disk selector and said control are housed in said kiosk housing.

5. The video game apparatus in claim 1 including a credit acceptor.

6. The video game apparatus in claim 5 including speakers for producing audio from said video game player.

7. The video game apparatus in claim 1 including speakers for producing audio from said video game player.

8. The video game apparatus in claim 1 for use with a plurality of game controllers.

9. The video game apparatus in claim 1 wherein said disk selector comprises keypad.

10. The video game apparatus in claim 9 wherein said title display comprises a title rack operable to hold a printed game jacket.

11. The video game apparatus in claim 1 wherein said title display comprises a title rack operable to hold a printed game jacket.

12. The video game apparatus in claim 1 wherein said disk selector comprises a touch screen defined with said video display.

13. The video game apparatus in claim 12 wherein said title display comprises images of videodisks displayed on said video display.

14. The video game apparatus in claim 1 including a default mode in which said control retrieves a particular videodisk to transfer to say video game player unless a user has selected a different videodisk.

15. The video game apparatus in claim 1 wherein said control displays attract video on a video display when said video game player is not in use.

16. A method of demonstrating video games stored on videodisks for the purpose of marketing, selling or merchandising video games, comprising:
providing a video game player having a videodisk player, at least one game controller, and a video display, said videodisk player having a disk interface for reading game data on a videodisk, said videodisk player receiving user input from said at least one game controller and displaying game images with said video display;
storing multiple videodisks with a disk storage device;
displaying to users images of videodisks that are in said disk storage device;
providing a videodisk transfer device and a user operable videodisk selector;
receiving user selections with said videodisk selector and retrieving a videodisk with said videodisk transfer device selected with said selector at said storage device and transferring the selected videodisk to said video game player.

17. The method of claim 16 wherein said at least one controller, said videodisk selector, and said video display are located remote from said videodisk player, said storage device and said videodisk transfer device.

18. The method of claim 17 including providing a kiosk for said at least one game controller, said videodisk selector and said video display in a kiosk.

19. The method of claim 16 including providing a kiosk for said video game player, said disk storage device, and said disk selector.

20. A method of playing video games stored on videodisks, comprising:
providing a video game player having a videodisk player, a game controller, and a video display, said videodisk player having a disk interface for reading game data on a videodisk, said videodisk player receiving user input from said at least one game controller and displaying game images with said video display;
storing multiple videodisks with a disk storage device;
displaying to users images of videodisks that are in said disk storage device;
providing a videodisk transfer device and a user operable videodisk selector;
receiving user selections with said videodisk selector and retrieving a videodisk with said videodisk transfer device selected with said selector at said storage device and transferring the selected videodisk to said video game player.

21. The method of claim 20 wherein said at least one controller, said videodisk selector, and said video display are located remote from said videodisk player, said storage device and said videodisk transfer device.

22. The method of claim 21 including providing a kiosk for said at least one game controller, said videodisk selector and said video display in a kiosk.

23. The method of claim 20 including providing a kiosk for said video game player, said disk storage device, and said disk selector.
